(19) United States
(12) Patent Application Publication
(10) Pub. No.: US 2003/0026732 A1
(43) Pub. Date: Feb. 6, 2003

(54) Continuous processing automated workstation

(76) Inventors: Steven J. Gordon, Weston, MA (US); Anthony J. Christopher, Andover, MA (US); Alex G. Liberman, Sharon, MA (US); Richard J. Keane, Melrose, MA (US); Kenneth M. Caron, Tewksbury, MA (US); Hani M. Sallum, Cambridge, MA (US); Jayanth Prabhakar, Bedford, NH (US)

Correspondence Address: David J. Powsner, One International Place, Boston, MA, 02110-2699, US

(21) Appl. No.: 10/179,916

(22) Filed: Jun. 24, 2002

Related U.S. Application Data
(63) Continuation of application No. 09/419,179, filed on Oct. 15, 1999, now abandoned.
(60) Provisional application No. 60/110,605, filed on Dec. 2, 1998.
(60) Provisional application No. 60/104,617, filed on Oct. 16, 1998.

(51) Int. Cl. G01N 35/00; B01L 3/02; G01N 35/10

(52) U.S. Cl. 422/63; 422/100; 436/43; 436/46; 436/48; 436/49; 436/54; 436/149; 436/150; 436/180

(57) ABSTRACT

An automated workstation capable of continuous, non-stop processing of specimens includes an environmentally controlled storage area that holds multiple cassettes containing specimen plates. A robotic arm for processing the specimens, e.g., by grasping the plates, moving them from the cassettes to other apparatus contained within the workstation, and placing the plates back in the cassettes. An interlock mechanism prevents the operator and robotic arm from simultaneously accessing a cassette. Novel robotic arms, robotic arm positioning mechanisms, plate handling mechanisms, effector tip/plate washing mechanisms, thin-walled pipetters, back-flushing mechanisms and fluid level detection mechanisms, as well as methods for operating the same, facilitate continuous operation of the workstation along with compactness, high throughput and high accuracy of operation. Narrow, thin-walled capillary-like pipetters serve as both means for acquiring and processing small quantity specimens with high precision.

### REFERENCE TO RELATED APPLICATIONS

This application claims the benefit of priority of U.S. Patent Application Serial No. 60/110,605, filed Dec. 2, 1998, and No. 60/104,617, filed Oct. 16, 1998, the teachings of which are incorporated herein by reference.

### BACKGROUND OF THE INVENTION

This invention relates to the automated processing workstations and, more particularly, to systems and apparatus providing the continuous processing of specimens and compounds. The invention has application in the testing, synthesis and processing of biological samples, chemical compounds, and the like.

Biological and chemical laboratory work has traditionally been performed by scientists and technicians manually. The growth of the pharmaceutical industry and, more recently, of biotechnology has increased demands for throughput and accuracy beyond that which can be met by manual techniques. Robotics equipment makers have responded with automated workstations that now handle many of the testing functions and that, in the near future, stand to take over the bulk of synthesis.

Designs of the prior art workstations vary dramatically. U.S. Pat. No. 5,443,791, for example, discloses an automated laboratory system, with a “Cartesian” robotic arm that employs separate gear belts for driving respective x-axis and y-axis carriages. A motorized rack-and-pinion drive positions a z-axis “carriage” on which a pipette tip and other processing components are mounted. An electrical probe extending from the z-axis carriage is used to calibrate the arm position each time an analysis protocol is performed. A wash station provided at a fixed location within reach of the robotic arm is used to clean the pipette tip.

U.S. Pat. No. 5,455,008 discloses a robotic DNA sequencing system in which a robot arm is slidably mounted for radial motion on a housing that moves vertically on a shaft. The shaft, itself, is attached to a swivel plate for angular rotation. A “hand” attached to the arm is used to carry specimen-containing microliter plates from refrigerated storage compartments to a work surface. To compensate for inadequacy in arm control, force sensors are utilized to sense and prevent breakage of pipette tips that are also attached to the arm.

U.S. Pat. No. 4,271,123, on the other hand, suggests the use of a rotating disk to present vials to an aspiration arm that withdraws samples for purposes of performing automated fluorescent immunoassays. Wash fluid is siphoned from a separate, stationary rinse container to wash the test assembly.

U.S. Pat. No. 4,835,707 discloses an apparatus for automatic analysis of enzyme reactions that utilizes an articulated robot arm equipped with an end-mounted chuck to grasp and move objects, such as sample tubes, reaction tubes and pipettes. An apparatus for transferring fluids to microliter trays wells, according to U.S. Pat. No. 4,554,839, has a horizontally indexable tray to position the wells under a head containing pipette tips. U.S. Pat. No. 4,730,631 discloses a stationary washing station that is used to clean an automated workstation probe tip without splashing.

Notwithstanding the foregoing, several challenges remain for automated workstation designers. As the competition increases to create new pharmaceuticals, for example, buyers demand workstations that can accommodate longer processing runs with greater numbers of specimens, yet, without degradation of accuracy. With the skyrocketing cost of laboratory space, they also demand workstations that are as compact as possible.

A goal of this invention, accordingly, is to provide such workstations and methods for operation thereof.

A more particular object is to provide an automated workstation capable of continuous, high throughput and high accuracy processing of biological, chemical and other specimens and compounds.

A related object of the invention is to provide a high-capacity automated workstation that has a relatively small “footprint” and that does not consume undue space.

Another object of the invention is to provide improved methods and apparatus for identifying, grasping and moving specimens within an automated workstation. A related object of the invention is to provide improved methods and apparatus for translating a robotic arm within an automated workstation. Another related object of the invention is to provide improved methods and apparatus for positioning pipettes and other processing apparatus that are contained on a robotic arm.

Yet another object of the invention is to provide improved methods and apparatus for flushing or rinsing containers (e.g., slides, plates or trays) that hold specimens processed within an automated workstation. A related object is to provide methods and apparatus for flushing or rinsing pipettes and other processing apparatus that are carried on a robotic arm within such a workstation.

Still a further object of the invention is to provide improved methods and apparatus for detecting the presence or levels of fluids contained within pipettes and other processing apparatus carried on a robotic arm within an automated workstation.

Still another object of the invention is to provide improved methods and apparatus for processing chemical, biological and other samples. A further object is to provide such methods and apparatus as facilitate the processing of samples in small volumes. A still further object is to provide such methods and apparatus as permit the processing of samples with high throughput.

### SUMMARY OF THE INVENTION

The foregoing objects are among those attained by the invention, which provides in one aspect an automated workstation capable of continuous, non-stop processing of specimens. The workstation includes a storage area that holds multiple cassettes containing specimens compounds or other materials to be analyzed or used in conjunction therewith (collectively, “specimens”) which, preferably, are maintained on slides, microliter plates, or the like (collectively, “plates”). The workstation also includes a robotic arm for processing the specimens, e.g., by grasping the plates, moving them from the cassettes to other apparatus contained within the workstation, and placing the plates back in the cassettes.

The multiple cassettes themselves are removably disposed within the storage area so that they can be placed in and removed from the workstation by a scientist, laboratory technician or other workstation operator. An interlock mechanism prevents the operator and robotic arm from simultaneously accessing a cassette. This prevents operator or equipment injury and, thereby, facilitates continuous processing, e.g., of specimens contained in other cassettes in the storage area.

According to related aspects of the invention, external panels cover the storage area to protect the specimens and to prevent the operator from slidably inserting or removing cassettes. Internal panels likewise maintain the specimen storage environment and prevent the robotic arm from manipulating plates within the cassettes. The interlock mechanism prevents the operator from opening the external panel covering a given cassette and/or moving a cassette therein when the internal panel for that same cassette is open or if the robotic arm is otherwise accessing a plate therein. The interlock mechanism can additionally and conversely prevent the robotic arm or its control circuitry from opening the internal panel covering the plates within a cassette when the external panel for that cassette is open.

Further aspects of the invention provide an automated workstation of the type described above in which the specimen storage area is environmentally maintained, e.g., refrigerated. To this end, environmental control apparatus generates cooled, warmed, humidified, dehumidified or other environmentally controlled air (or other such gas or fluid) which is passed to the storage area, e.g. through vias or holes in a workstation wall separating the storage area from the environmental control apparatus. The aforementioned cassettes are constructed with open or partially open sides in order to permit that air to contact the plates and/or specimens.

Still further aspects of the invention provide an automated workstation of the type described above including a work area in which transfer stations, laboratory equipment and further pieces may maintained for use in manipulating and processing the specimens or specimen plates. External access panels, preferably, separate from those described above, provide access to the work area for installation and removal of such pieces. The work area can be disposed adjacent to the cassette storage area. If two or more storage areas are provided (as is the case in preferred aspects of the invention), those storage areas are conveniently disposed at the periphery of the work area.

Yet still further aspects of the invention provide an automated workstation of the type described above in which robotic arm is disposed on a track above the work area (and, optionally, above the cassette storage area). A belt drive mechanism of the type described below utilizes a single integral belt to position the arm in the x-axis and y-axis directions, e.g., to move it adjacent to the storage area for access a plate therein and to move it over apparatus in the work area to deposit the plate thereon.

To attain compactness and economy of motion, the arm can include both motor driven and pneumatically extensible sections to position “effectors,” e.g., plate grippers, plate rinse mechanisms, probes, pipettes and other such processing apparatus, in the z-axis direction. In one aspect of the invention, for example, a motor disposed on a frame of the arm turns a lead screw within a “nut” disposed on a carriage that, itself, is positioned along the x- and y-axes via the aforementioned belt drive. A pneumatic section, which is mounted on the frame and which also moves as the lead screw is turned, can be extended to increase the reach of the arm. In operation, the motor-drive and pneumatic sections can be extended to enable a plate contained in a lower-most portion of the storage area to be gripped, and they can be retracted to permit that plate to be deposited on the top of processing apparatus in the work area.

A workstation as describe above can also utilize a plate identification mechanism to facilitate continuous processing. A detection mechanism disposed on the robotic arm can be used to identify cassettes or plates in the storage area. In one aspect of the invention, for example, “bar code” labels attached to each specimen plate to identify them and, optionally, indicate their type and contents. A bar code reader disposed on the pneumatically extensible section of the robotic arm is used to “inventory” the plates prior to, or in the midst of, processing. As a consequence, the workstation is capable of automatically identifying and properly handling plates inserted into the storage area during processing operations.

A plate handling (or “basic”) effector that is attached to the robotic arm and particularly, for example, its pneumatically extensible portion contributes to workstation compactness and high plate capacity. The effector includes telescoping or otherwise extensible forks for engaging a plate from the side, and grippers for engaging a plate from the top. Use of the telescoping forks enables the arm to remove plates from, or plates in, the cassette where they are closely stacked. The forks can also be used to move the plates to/from side-loading processing apparatus in the work area. For top-loading processing apparatus, the grippers are used. To this end, according to one aspect of the invention, the forks are employed to retrieve a plate from a cassette and to deposit the plate on a transfer station disposed in the work area. The arm is repositioned above the plate and the grippers are employed to transfer it to the top-loading apparatus.

Still further aspects of the invention provide a workstation and/or robotic arm of the types described above with pipette-type effectors with back-flushing apparatus. According to these aspects of the invention, plungers that are normally used to expel fluids from the pipettes are backed out to permit a pressurized wash fluid, provided through vias in the effector mounts, to flush over the plungers and through the barrels and tips. In a related aspect of the invention, a valve disposed at the via outlet can be closed, forcing the pressurized fluid through the barrels and tips with greater force.

Still further aspects of the invention provide a workstation and/or robotic arm of the types described above with apparatus for rinsing the ends of effectors such as pipettes and probes. To this end, a wash cup is disposed on the robotic arm or, preferably, on mounts of the desired effectors themselves. Between processing operations, the wash cup is rotatably or otherwise positioned into a working position over the effector tip. Wash fluid is pumped through the tip (via the back flushing mechanism described above) into the cup to effect cleaning. The wash cup, according to further aspects of the invention, can include a plate rinse port for directing wash fluid onto a plate disposed below the effector.

Use of “on board” tip wash, plate rinse and back-flush mechanisms of the types described above contribute further to the compactness and throughput of the workstation by eliminating the prior art requirement for the use of stand-alone wash stations disposed within the work area.

Still yet further aspects of the invention provide a workstation and/or robotic arm of the types described above with apparatus for monitoring the fill levels of pipette-type effectors. A light source, such as an LED, disposed on one side of a pipette is detected by a photodetector at the other side. By monitoring the output of the photodetector, the fill level of the pipette can be determined. Such mechanisms contribute to the accuracy and throughput of the workstation by facilitating detection of pipette “misfires.”

In still further aspects, the invention provides methods and apparatus for acquiring and processing samples in narrow, thin-walled pipetters without transferring them to wells, vials, or other reaction vessels. Since the samples remain enclosed inside these “nano” pipetters, their volumes can be carefully controlled without fluctuations due to factors such as evaporation. This allows the processing of samples as small as a few nanoliters. Moreover, utilization of such narrow, thin-walled reaction vessel(s) permits the external stimulus to be uniformly and precisely applied to the samples.

In yet another aspect, the present invention provides automated workstations as described above having robotic arm with effectors that include one or more narrow, thin-walled pipetters as described above for processing small volume biological and chemical samples. Such processing includes, but is not limited to, thermal, magnetic, radioactive and mechanical manipulation.

In one aspect, small volume fluid samples are thermally processed by aspirating them into the thin-walled pipetters using a close-fitting plunger. More than one sample may be aspirated into the pipetters and mixed by moving the plunger back and forth repeatedly. The samples are thermally processed by placing the pipetters in one or more thermally controlled environments such as an oven, cooler, air stream, fluid stream, or solid block. For example without limitation, such thermal processing can be used as part of an overall methodology for effecting polymerase chain reaction and for DNA sequencing reactions.

In yet another aspect, the present invention provides for a narrow thin-walled pipetter as described above that includes a close-fitting plunger slidably disposed within its inner diameter or chamber. The plunger may either have a moving seal to the inside walls of the chamber or have a close fit that restricts the flow of air and acts as a seal. The end of the chamber opposite the plunger may optionally be fitted with a metal tip of a smaller diameter to aid in fluid aspiration and dispensing.

Still other aspects of the invention provide methods of operating automated workstations of the types described above. While yet other aspects of the invention provide robotic arms, robotic arm positioning mechanisms, plate handling mechanisms, effector tip/plate washing mechanisms, back-flushing mechanisms, fluid level detection mechanisms, and narrow thin-walled pipetters of the types described above, as well as methods for operating the same.

Still further aspects of the invention provide methods of processing chemical and biological or other components paralleling the operations described above.

These and other aspects of the invention are evident in the drawings and in the description that follows.

### BRIEF DESCRIPTION OF THE DRAWINGS

A further understanding of the invention may be attained by reference to the drawings, in which

FIGS. 1-4 depict the overall structure and operation of a continuous processing automated workstation according to one practice of the invention;

FIG. 5 depicts a single-belt drive mechanism according to one practice of the invention for positioning a robotic arm along the x- and y-axes;

FIGS. 6A-6F depict how the drive mechanism of FIG. 5 effects motion of x- and y-robotic arm carriages in a continuous processing automated workstation according to one practice of the invention;

FIGS. 7A-7F and 8A-8G depict a robotic arm and a “basic” effector according to practices of the invention, as well as their use in inventorying specimen plates and plate handling;

FIGS. 9A-9C depict a robotic arm and a pipette-type effector according to practices of the invention, as well as their use in processing specimen plates;

FIGS. 10A-10G depict a pipette-type effector with an on-board tip wash/plate rinse mechanism according to one practice of the invention;

FIGS. 11A-11B and 12A-12B depict a pipette-type effector with a fluid fill level detection mechanism according to one practice of the invention; and

FIGS. 13A-13C depict a pipette-type effector with a back-flush mechanism according to one practice of the invention.

FIG. 14 depicts a narrow, thin-walled pipetter according to the invention.

FIG. 15 depicts the sequential processing steps for purifying nucleic acids within a thin-walled pipetter.

### DETAILED DESCRIPTION OF THE INVENTION

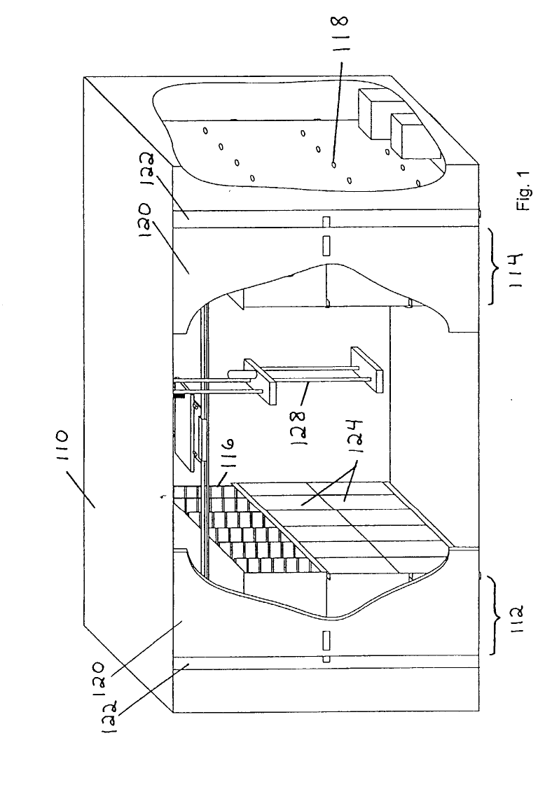

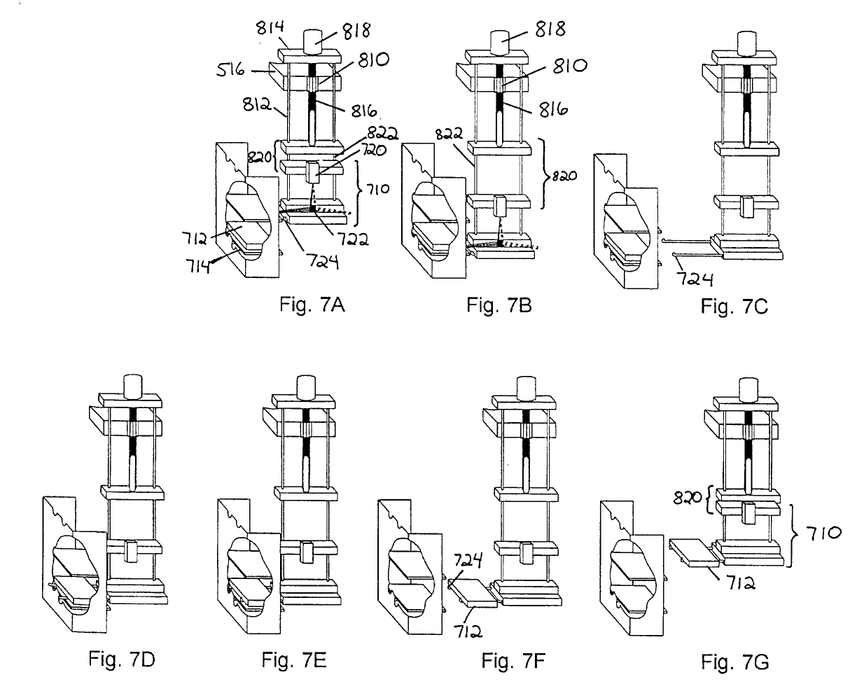

FIGS. 1-4 illustrate an automated laboratory workstation 100 according to the invention. The workstation includes a housing 110, which in the illustrated embodiment comprises environmentally controlled storage areas 112, 114 for cassettes 116 of specimen plates, e.g., standard 96-well plates (see element 712 of FIG. 7A). Environmental control apparatus 113 in compartments 115 generates cooled, warmed, humidified, dehumidified or other environmentally controlled air (or other such gas or fluid) which is passed to the storage areas 112, 114 and work area 117, e.g. through vias or holes 118, as illustrated. The cassettes are preferably open sided, e.g., as shown in FIG. 3, or otherwise configured to permit that air to contact the plates and/or specimens.

The workstation has access panels 120 and 122 for covering and limiting operator access to the storage areas 112, 114 and work area 117, respectively. In the preferred embodiment shown in FIG. 1, the panels 120, 122 slide laterally to allow such access, though pivoting or other mechanisms for movement of the panels may be used instead. Inner panels 124, which likewise cover and limit access to plates within the storage areas, are automatically opened in connection with motion of the robotic arm 128. For ease of illustration, no panels 124 are shown for the top row of cassettes 116 in storage area 112. Though the illustrated workstation includes only two external panels 122 for the cassettes, those skilled in the art will appreciate that further such panels may be provided. Thus, for example, individual external and internal access panels may be provided for each respective cassette. Likewise, though the illustration shows one internal panel 124 per cassette zone (e.g., per six plates), an alternate embodiment can utilize fewer panels 124, e.g., two or three panels per side of the workstation.

In preferred embodiments, a electromechanical interlock (not shown) prevents the operator (e.g., scientist or laboratory technician) from opening the external panel 122 covering a given cassette if the internal panel 124 for that same cassette is open for the robotic arm 128 to access a plate of that cassette. The interlock, further, prevents the robotic arm control circuitry from opening the internal panel 124 covering the plate within a cassette when the external panel 122 for that cassette is open. Such an interlock facilitates use of the workstation for continuous processing, since cassettes can be introduced into (or removed from) the workstation through one panel 122, without interrupting processing of cassettes covered by the other panel 122. A further interlock (not shown) likewise prevents the operator from opening the external panel 122 if the robotic arm is in motion and, conversely, prevents the robotic arm from moving if the external panel 122 is open.

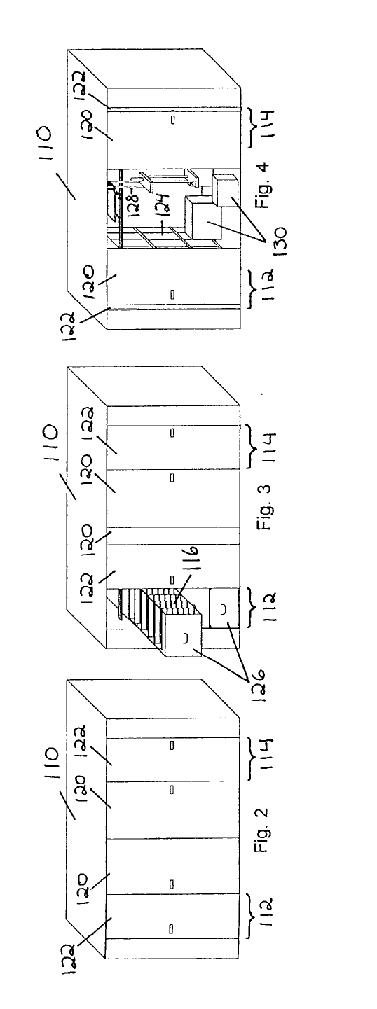

FIG. 2 shows the workstation of FIG. 1 with outer panels 120 and 122 closed. This is the typical condition of the panels during processing of specimens, though as discussed above, operation can continue even with a panel 122 open, though not with panel 120 open.

FIG. 3 illustrates the loading or unloading of a specimen cassette 116 via an external access panel 122. In a preferred embodiment, the specimen cassette 116 slides on fix guides (not shown) mounted on the inner side walls of each storage area 112, 114. Alternate mechanisms may also be utilized in place of such guides, e.g., telescoping rails. The aforementioned interlock can be configured to prevent a cassette 116 from sliding onto or off of these rails and, therefore, from being inserted into or removed from the storage area 112, when the robotic arm 128 is accessing a plate in the cassette 116.

FIG. 4 shows how the work area 114 of the workstation can be accessed through the center panels 120, e.g., for purposes of installing or removing transfer stations, filling or exchanging fluid reservoirs, laboratory equipment and further work pieces 130 for use in manipulating and processing specimens or specimen plates. Visible in that drawing, as well as FIG. 1, is a robot arm 128 for use in moving the plates to/from the cassettes 116 and the work pieces 130. The robot arm 128 is also used for performing processing of the plates, e.g. pipetting fluid into and out of the specimen wells.

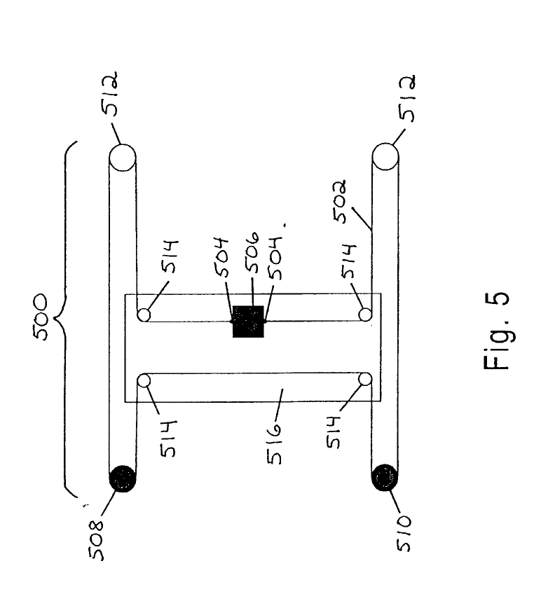

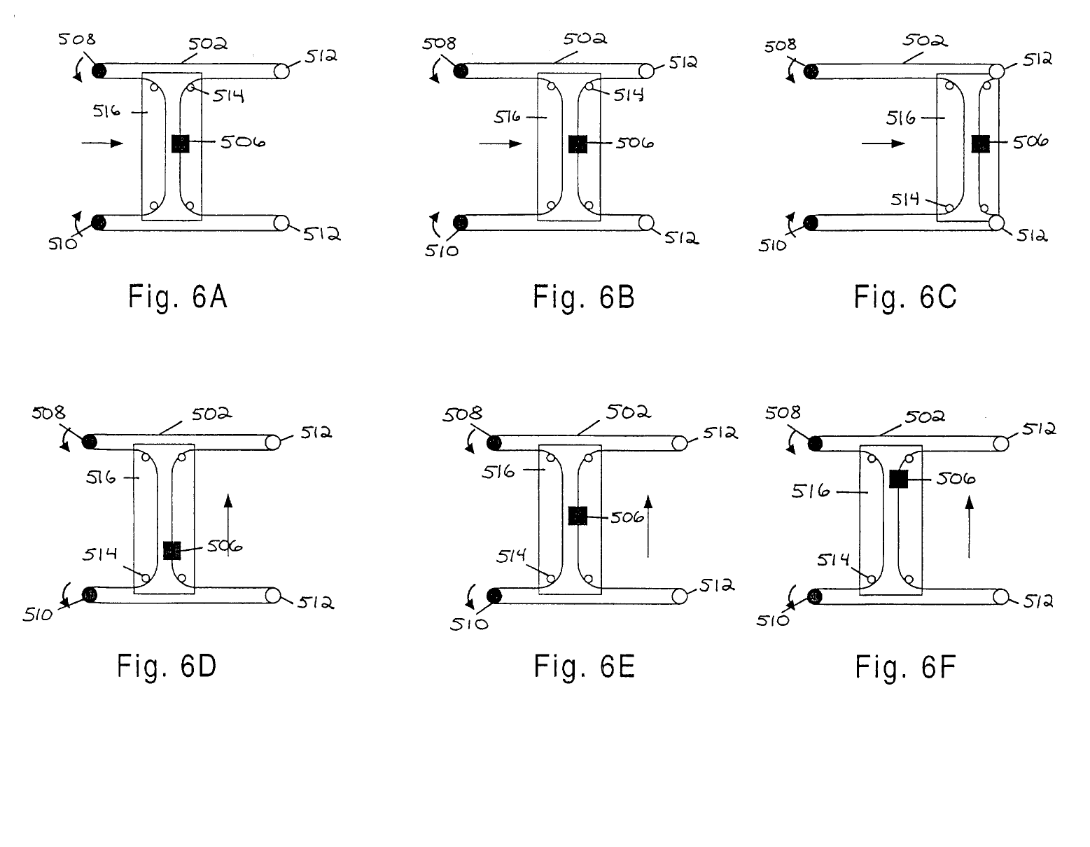

With reference to FIG. 1, robotic arm 128 is disposed on a track 129 above the work area 117 and storage areas 112, 114. A belt drive assembly 500, most clearly visible in FIGS. 5 and 6, is used to move the arm 128 in the x-y plane. The belt drive assembly 500 disposed on track 129 utilizes a single, integral belt 502 to position an x-axis carriage 516 and y-axis carriage 506 on which the arm 128 is mounted. Y-axis carriage 506 moves in the y-axis direction (vertically, as shown in the drawings) on the x-axis carriage 516, which itself moves in the x-axis direction (horizontally, as shown in the drawings) on the track 129.

In the illustrated embodiment, belt 502 is affixed on opposing sides of y-axis carriage 504, as illustrated, and is wound in an “H” configuration around drive wheels 508, 510 and idler wheels 512 and 514, as shown. The idler and drive wheels 508-512 are coupled to the track 129 or to the housing 110 of the workstation 100 and, thus, are stationary relative to the carriages 506, 516 and arm 128. Two of those wheels 512 may be mounted directly or held by springs or other such biasing mechanisms (not shown) so as to increase or adjust tension in the belt. Idler wheels 514 are mounted to the x-axis carriage 516, as shown, to complete the winding path of the belt 502. The system may optionally include wheels affixed to the frame along the path of the belt, e.g., adjacent wheels 512, which decrease the mechanism width and, thereby, permit the use of a larger x-axis carriage 516 for more travel of y-axis carriage 506.

Though the illustrated embodiment utilizes two drive wheels and six idler wheels, those skilled in the art will appreciate that other combinations of drive and idler wheels may be utilized to attain single-belt drive in the manner described herein. Moreover, it will be appreciated that the wheels may comprise gears, pulleys, posts or other structures about which the belt may be routed and/or by which it may be rotated.

The use of the assembly to move the carriages 506, 516 and, therefore, the robot arm in both x- and y-directions is illustrated in FIGS. 6A-6F. FIGS. 6A-6C show how motion in the “positive” x-direction is attained. Specifically, with drive wheel 508 rotated counterclockwise and drive wheel 510 rotated clockwise in an equal amount, as shown in FIG. 6A, the belt 502 is drawn against idler wheels 512, thereby moving the carriage 516, and the attached idler wheels 514 and robot arm 528 via y-axis carriage 506, to the right, as shown in FIGS. 6B and 6C. Clockwise rotation of drive wheel 508 combined with equal counterclockwise rotation of wheel 510, conversely effects motion of the carriage to the left (or “negative” x-direction).

FIGS. 6D-6F show how motion in the y-direction can be accomplished. If drive wheels 508 and 510 are both rotated counterclockwise, as shown in FIG. 6D, there will be no net force on the x-axis carriage 516 but rather, on the y-axis carriage 506. This will cause that carriage 506 to move upward or in the “positive” y-direction along the belt path, as shown in FIGS. 6E and 6F.

As will be apparent to those skilled in the art, combinations of x- and y-direction motion may be achieved by rotation at different rates of drive wheels 508 and 510. X-direction motion is always accomplished by motion of both carriages 506, 516 and attached arm 128, while y-direction motion is achieved by motion of carriage 506 and arm 128 relative to the carriage 516.

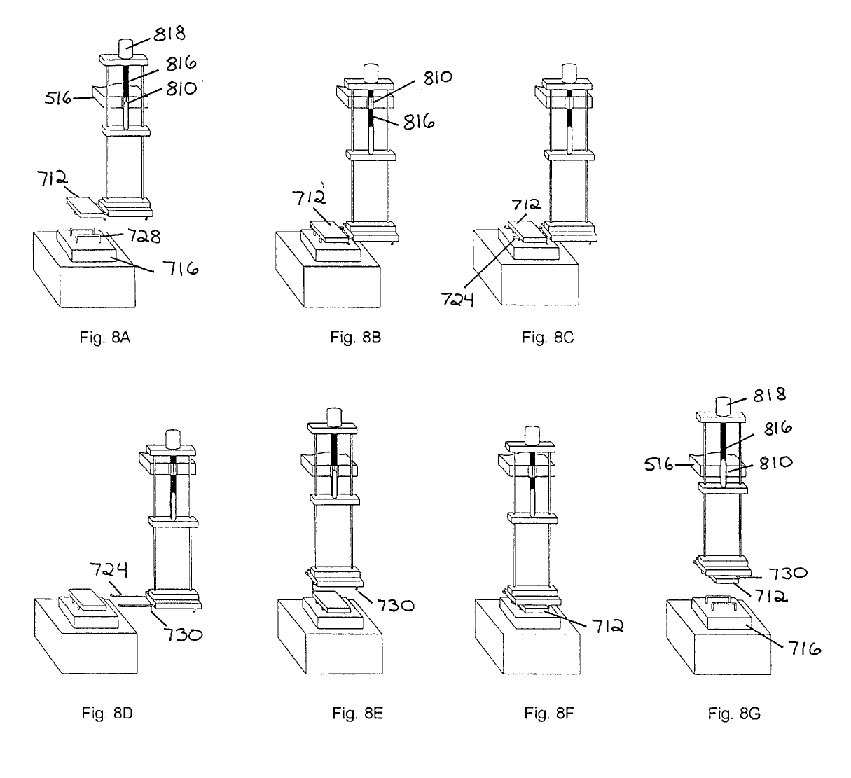

In addition to the x-y mobility afforded by the belt drive assembly 500, apparatus is also provided for extending the arm 128 in the z-direction, as shown in FIGS. 7 and 8 and described below. With reference to those illustrations, the arm 128 utilizes a combination of motor and pneumatic drives for positioning guide rails and support plates upon which plate handling (or “basic”) effectors and other types of end effectors are mounted.

The arm 128 includes a lead screw 816 that turns within a “nut” 810 or other threaded element affixed to the y-axis carriage 506. A frame, which is comprised of top stabilizer plate 814, bottom stabilizer plate 815, and guide rails 812, is coupled to the lead screw as illustrated. The lead screw 816 is rotated by servo motor 818 or other such device affixed to one of the stabilizer plates, here, top stabilizer plate 814. Rotation of the lead screw 816 within the nut 810 raises or lowers the frame (i.e., stabilizer plates 814, 815 and guide rails 812), as well as any assemblies thereon (e.g., basic end effector 710) relative to the y-axis carriage 506.

The arm 128 also includes a pneumatically extensible section 820 that can be used to further extend its range along the z-axis range. By mounting effectors, such as basic end effector 710, on section 820, their range of vertical motion can be extended without requiring a correspondingly long lead screw 816.

The extensible section 820 comprises a pneumatic piston or other such apparatus that is mounted on bottom stabilizer plate 815 for extending telescoping or extending rods 822, seen most clearly in FIG. 7. FIGS. 7A and 7G show the rods 822 in a retracted (high) position, while FIGS. 7B-7F show the rods 822 in an extended (low) position. It is preferred that the lead 816 screw has a working length at least as long as the “throw” of the rod 822. This ensures that fine z-axis control is available through the lead screw 816 for the entire vertical range of the arm.

As discussed above, the robot arm 128 is movable in the x-, y- and z-directions. This versatile range of motion allows the arm 128 to be used for a variety of plate handling and plate processing steps. For example, a system and method for using the robot arm 128 to remove a specimen plate 712 from a cassette 116 and place it on work surface 716 is shown in FIGS. 7 and 8. Also shown are novel apparatus and methods for inventorying plates 712 in the cassette 116. Other functions can be achieved through the use of a variety of specialty effectors, e.g., pipette arrays.

In order to use the arm 128 to inventory cassettes and plates, the assembly 710 is moved to a position adjacent to the cassette 116 and/or plates 712 so that identifying markings on the them can be “read” by sensor 720 which, in the illustrated embodiment, comprises a bar code reader or other such optical sensing device. A beam splitter 722 is preferably employed to provide optical sensing pathways in multiple directions, as illustrated. This permits the sensor 720 to “read” bar code tags or other indicia on disposed on either side of the assembly 710 without reorientation (e.g., rotating the assembly 710 or arm 120). Those tags can identify the respective cassettes or plates and, optionally, indicate their type and contents, which information can be used in subsequent plate handling, processing or reporting operations. To perform an inventorying function, the arm 128 and, particularly, the assembly 710 is repositioned from cassette to cassette and from plate to plate in order that information regarding them can be recorded.

Referring to FIGS. 7C and 7D, a basic end effector is attached to the pneumatically telescoping section of the arm 128 to permit grasping and moving plate 712 so that it may be moved to/from the cassette 116 and the storage areas 112, 114. For this purpose, the effector 710 includes telescoping arms or forks 724 that extend from the assembly 710 for positioning under the plate 712, as shown in FIGS. 7C and 7D, so that it can be lifted from (or deposited in) the cassette shelves. The forks 724 may include hooked ends or other structures for better grasping the plates by pinching them in a retracted state after they are picked up. Also, the ends of forks 724 are preferably tied together with a crossbar (not shown) to equalize their speeds of extension and retraction.

Once the forks 724 are under the plate, the arm 128 is raised slightly to lift the plate 712 clear of retaining flanges present on the cassette shelves, as shown in FIG. 7E. The forks then retract to grasp the plates. The arm 128 is then moved to clear the plate 712 from the cassette, as shown in FIG. 7F. Once free of the cassette 116, the plate can be moved over a work surface 716 (e.g., the surface of a transfer station or other work piece), as shown in FIG. 8A.

The work surface 716 is preferably be provided with supports 728 to accommodate the forks 724 and, thereby, to facilitate placement and removal of the plates, as shown in FIG. 8. The assembly 710 can then be lowered to the transfer station with the forks 724 between the supports 728, so that the plate 712 rests on and is registered in the supports 728, as shown in FIG. 8B. The forks 724 can then extended to free the hooked ends from the plate, as shown in FIG. 8C, and the assembly 710 can be moved down, then, horizontally to fully clear the plate, as shown in FIG. 8D. The foregoing operations may be reversed to pick up a plate from a work surface and insert it into a cassette 116.

Though illustrated basic end effector 710 has pickup forks 724 on only one side, preferred embodiments include such forks on both sides of the effector 710. This permits the arm 128 to handle plates in either storage area 112, 114, without reorientation (i.e., without rotating the effector 710 or the arm 128).

In addition to engaging plates from the side with forks 724, a preferred basic end effector 710 includes downwardly extending grippers 730 for engaging plates from the top and, thereby, facilitating their movement to/form top-loading processing apparatus. The grippers, which can include hooked ends as shown in the drawings, move inwardly (relative to a central region 729 of the effector) in order to pinch or grasp a plate, as well as outwardly in order to release a plate. Additionally, they can be extended downwardly via robot arm 128 to facilitate grasping or retracted for storage.

Use of the grippers is illustrated in FIGS. 8E-8G. In the illustration, the assembly 710 is maneuvered over the plate and lowered to a position slightly above it, as shown in FIG. 8E. The assembly 710 is lowered further and/or the grippers 730 are brought together in order to grasp the plate, as shown in FIG. 8F. Once the plate is capture, the assembly is raised in order to lift the plate, as shown in FIG. 8G. The arm 128 can then be moved to transfer the plate to a different location, for example one not accessible using the fork 724 subassembly described above.

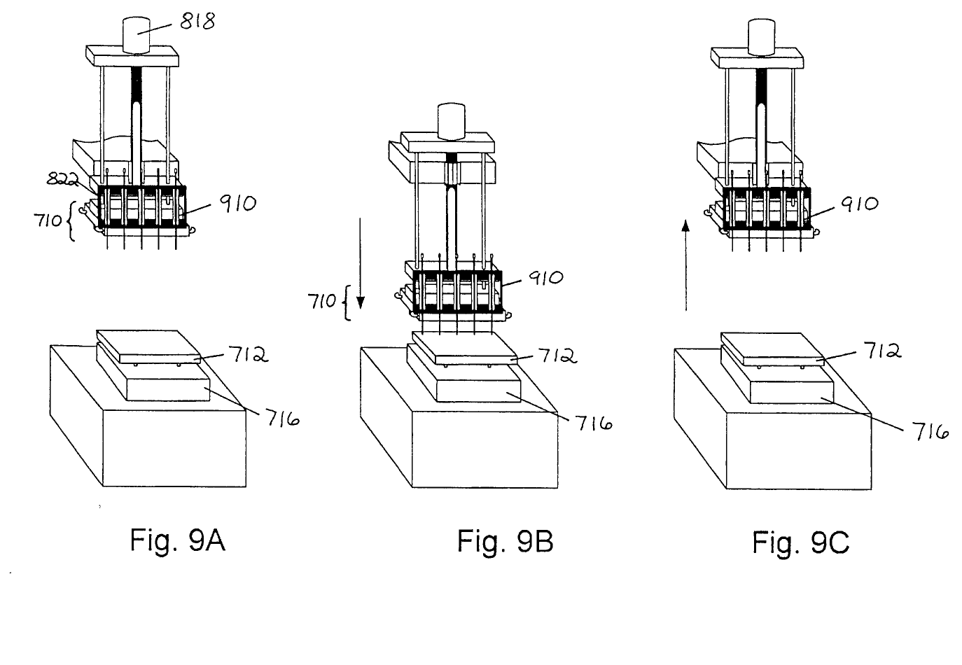

In addition to the basic end effector for plate handling, specialty effectors may be attached to the arm for use in performing a variety of processing tasks. FIG. 9 illustrates the action of such a specialty effector: a pipette array. As shown, a set of parallel pipettes 910 is mounted on the screw-driven portion of the arm, e.g., on bottom support 815 or rods 812. With the pneumatically-extensible portion 822 in the retracted position, the effector 910 can be moved via rotation of the lead screw 816 so that its tips are in position to inject fluids into or remove fluids from the specimen plate 712.

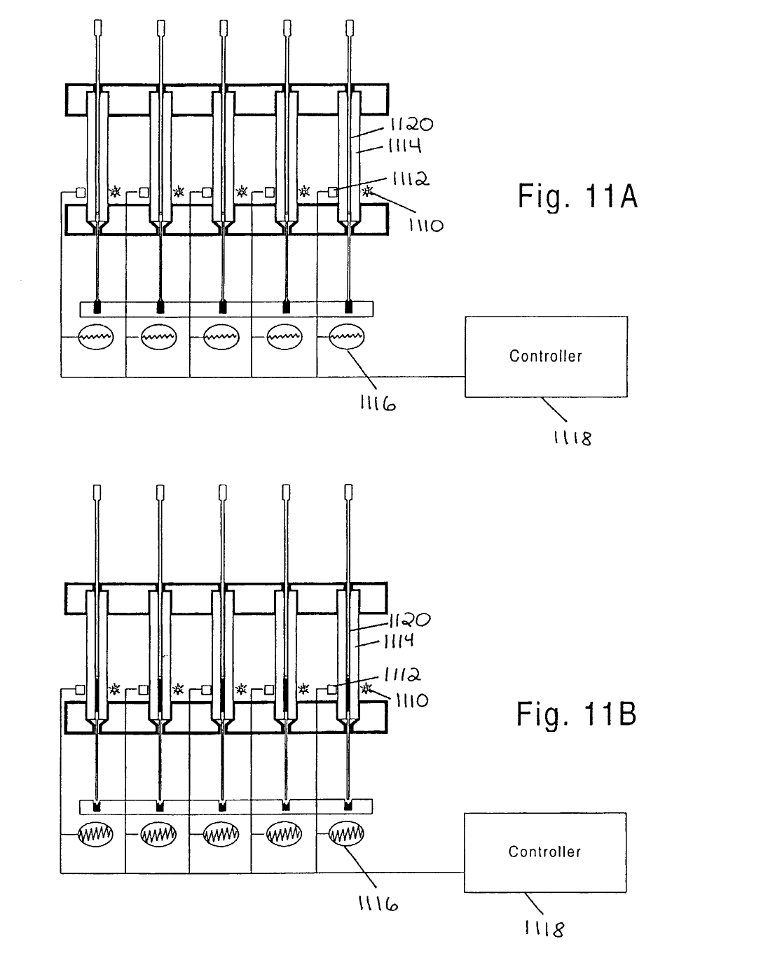

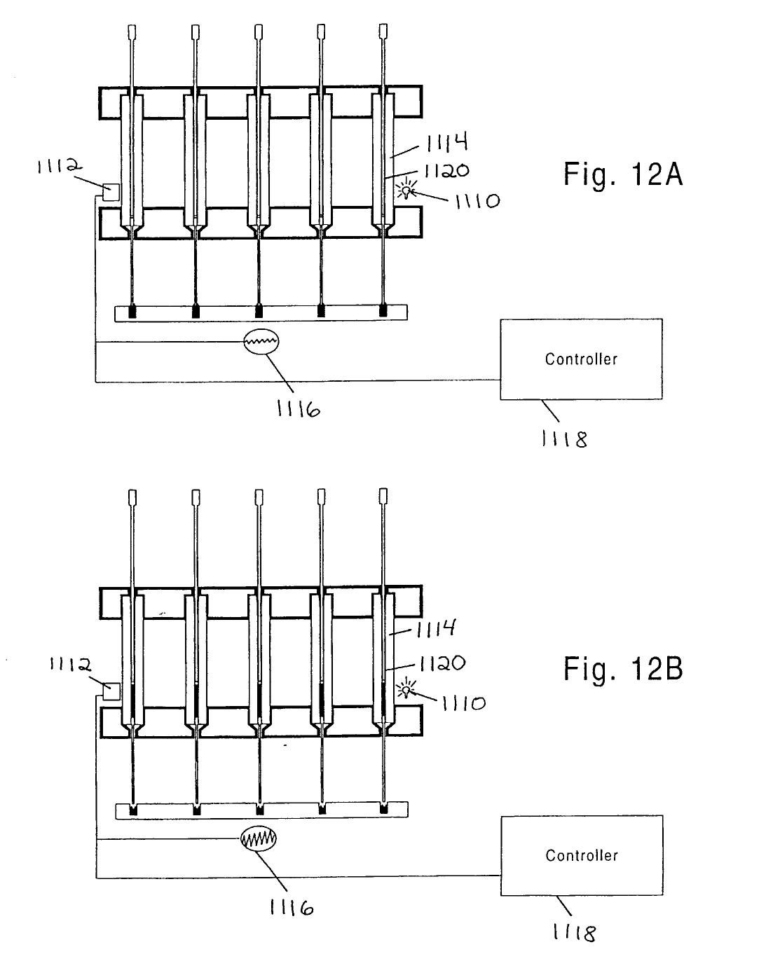

A system for determining fill levels in one or more pipettes may be included with such an array, as shown in FIGS. 11 and 12. With reference to FIG. 11, an LED 1110 (or other light source) and a photodetector 1112 is associated with each pipette. The LED 1110 and the photodetector 1112 are arranged so that light from the LED must pass through a pipette 1114 to reach the photodetector. The photodetector signal 1116 can then be monitored to determine whether the fluid level in the pipette is above or below the level of the LED 1110 and photodetector 1112. If the fluid level in the pipette is low, as shown in FIG. 11A, the signal 1116 produced by the photodetector 1110 will be small in amplitude due to refraction, as further described below. If the fluid level in the pipette is high, on the other hand, the signal 1116 will have a greater amplitude, as illustrated in FIG. 11B. This signal information is passed to a controller 1118, which utilizes the information to verify filling of the pipettes and, optionally, of the characteristics of the fill fluid.

FIG. 12 illustrates a related embodiment, in which a single LED/photodetector pair is used to monitor the fluid level in multiple pipettes. In this embodiment, light source 1110 and photodetector 1112 are disposed so that light from the source must pass through multiple pipettes 1114 to reach the photodetector. The photodetector signal 1116 will thus have a reduced amplitude due to refraction if any of the pipettes has a low fluid level, as shown in FIG. 12A. If all pipettes are filled above the level of the LED/photodetector pair, the amplitude of the signal 1116 will be increased, as shown in FIG. 12B.

The change in signal with fill level in both systems depends on the difference in the refractive index of air and of the fill fluid. The pipettes 1114 comprise a narrow channel 1120 through a thick body, as can be seen from the figures. The low curvature of the outside surface does not bend light entering the pipette from the LED 1110 significantly. When the light reaches the inside channel, however, it encounters a surface at a relatively oblique angle to the light path, due to the small radius of curvature of the channel 1118. If the material in the channel has a refractive index which differs significantly from that of glass, the path of the light will be bent and little light will reach the photodetector 1112. If the material in the channel has a refractive index similar to that of glass, the path of the light will not bend significantly, and much more light will reach the photodetector 1112. In preferred embodiments, an opaque non-reflective channel (not shown) may be provided between the pipette 1114 and the photodetector 1112, to absorb “bent” light and reduce the effects of reflections and scattered ambient light, thereby increasing the sensitivity of the system.

The response to the system may differ from that described above, for example when an opaque fluid is used. The system may be effectively used in such situations as long as the signal 1116 differs for a full and an empty tube 1114.

Calibration of this system thus depends in part on the refractive index of the fill fluid. In preferred embodiments, it is possible to adjust a set point threshold of the photodetector to adjust to differing fluid refractive indices. For example, a library of threshold set points may be provided so that the processing of the signal can be adjusted depending on the fluid used.

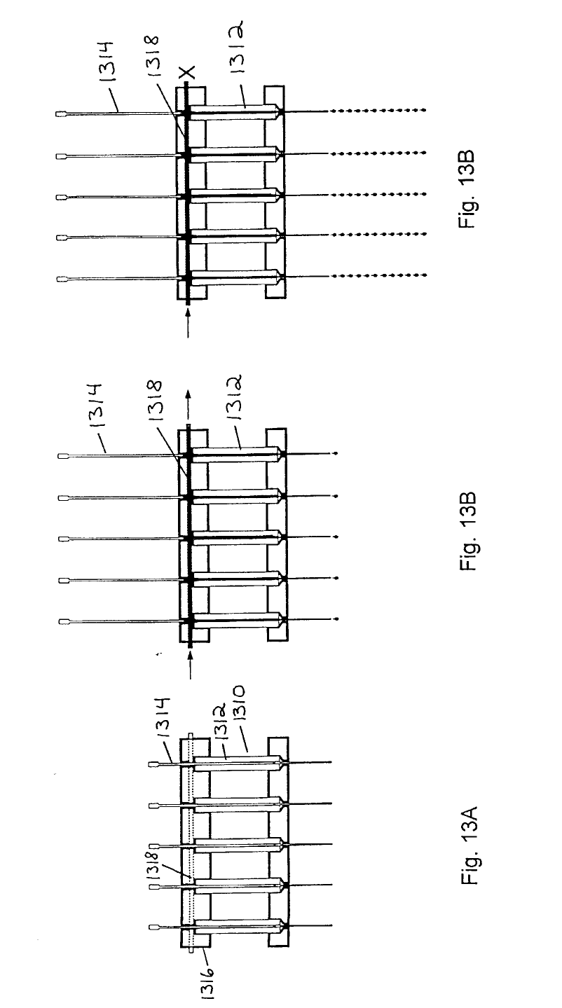

FIG. 13 illustrates a system for flushing one or more pipettes 1310, such as the array shown in FIG. 9. Each pipette comprises a body 1312 having a channel therethrough, and a plunger 1314 disposed in the channel for aspiration or expulsion of fluid through the pipette tip. The pipettes are mounted in a rack 1316 having a passage 1318 therein, which can be filled with distilled water or another cleaning fluid. When the pipettes are being used, the plungers 1314 extend into the pipette bodies 1312, blocking the water passage 1318, as shown in FIG. 13A.

When it is desired to clean the pipettes, for example to aspirate a different fluid, the plungers 1314 are withdrawn from the pipette bodies 1312. Water or other flush fluid can then flow through the passage 1318, as well as through the pipette channels, as shown in FIG. 13B. The flow of water through the pipette channels will generally be somewhat slow, due to the narrowness of the channels. If it is desired to flow more water through the pipettes, the outlet of the passage 1318 can be closed by a valve as shown in FIG. 13C. This blockage substantially increases the flow rate through the channels. The plungers 1314 can be reinserted into the pipette bodies to stop the flow of water and to eject any remaining water from the pipettes. In addition to facilitating flushing of the pipettes the illustrated arrangement helps to keep the pipettes in working fluid.

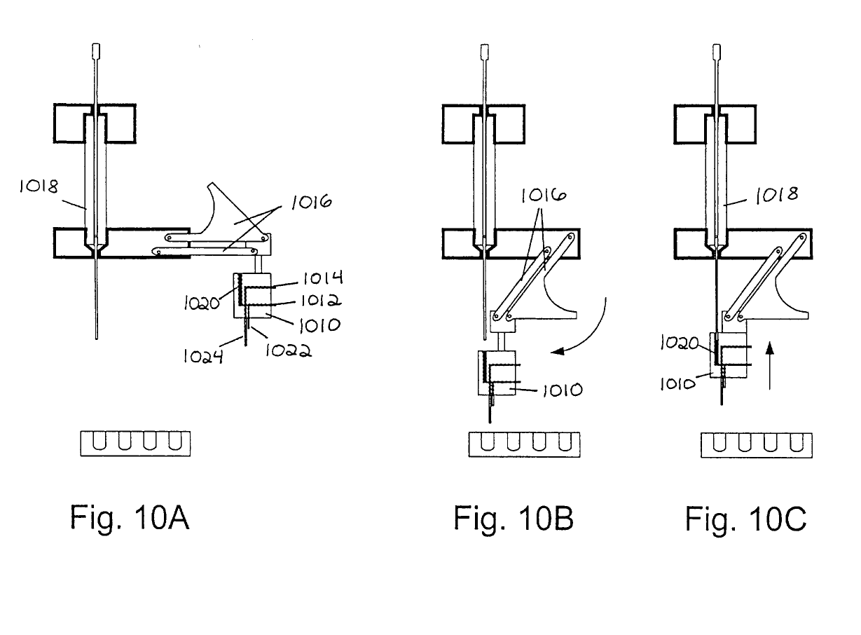

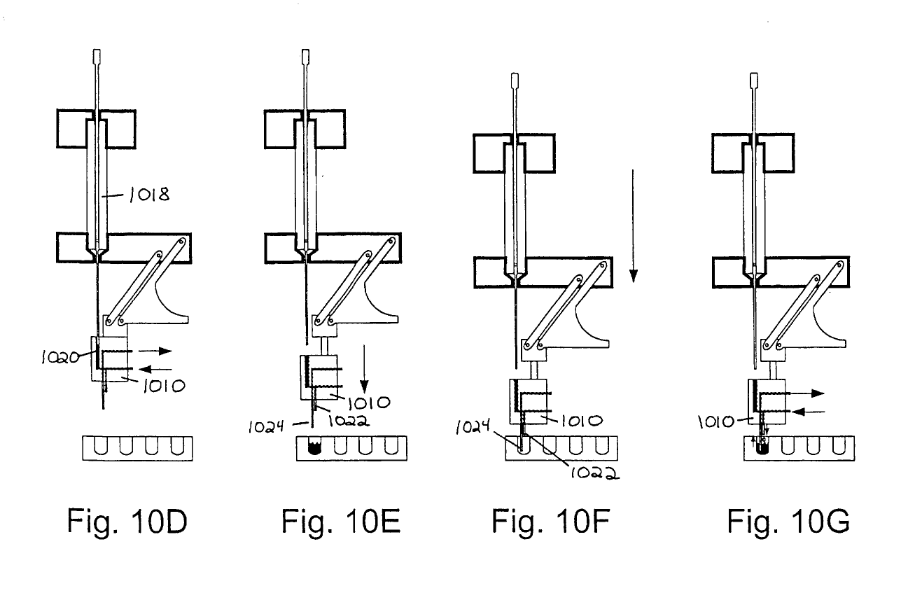

FIG. 10 illustrates a single pipette effector equipped with apparatus for cleaning pipettes and/or microliter plates. The effector comprises a washing element 1010, which includes a reservoir 1020 (which catches fluid from the pipette) and an outlet 1014 for fluid lines, which carry distilled water or other cleaning fluid. The outlet 1014 may be connected to a vacuum pump (not shown).

When pipetting or plate handling functions are being performed, the washing element 1010 will generally be located in its default or carrying position, shown in FIG. 10A. When it is desired to clean a pipette or plate, the washing element 1010 can be rotated swung into working position by action of connectors 1016, as shown in FIG. 10B. The washing element 1010 may then be moved to bring reservoir 1020 into contact with the pipette tip, as shown in FIG. 10C. Alternatively, the pipette 1018 can be moved to place the tip in the reservoir 1020 position while the washing element 1010 remains stationary.

Pipette flushing fluids (which are preferably introduced into pipette 1018 through channels and passages of the type shown in FIG. 13 and discussed below) exit from the pipette 1018 into reservoir 1020 for purposes of flushing the tip of the pipette. Those fluids are drawn from the reservoir via outlet 1014 as shown by arrows in FIG. 10D. The washing element is then returned to its working position, as shown in FIG. 10E. Multiple reservoirs 1020 may be provided when the cleaning effector is used with a pipette array, as shown in FIG. 9.

The washing element 1010 further comprises an irrigator 1022 and an extractor 1024 for cleaning the microliter plate. In use, as shown in FIGS. 10E-G, the extractor is brought into contact with a well of the microliter plate by movement of the entire assembly, and water flows from the inlet 1012 to the irrigator 1022, where it is dripped or sprayed into the well. The extractor 1024 may then be used to remove the water via the outlet 1014. In this function, the washing element 1010 may be moved independently of the pipette assembly, if desired.

Prior art in vitro processing of biological and chemical samples, e.g., for purposes of screening small molecules or sequencing nucleic acids, has generally required relatively large sample sizes. In conventional automated workstations, such samples are mixed and processed in wells of microtiter plates. The smallest sample size heretofore conventionally processed is approximately two microliters, a volume at which precision is only about 20% due to evaporation and other effects.

Embodiments of an automated workstation according to the invention permit the processing of still smaller samples with still greater precision. This entails aspirating or otherwise introducing the samples into narrow, thin-walled pipetters and—rather than transferring them to microtiter plate wells or other reaction vessels—performing processing on the samples while they are within the pipetters. By using such “nano-pipetters” or “thin-walled pipetters” (as they are alternatively referred to herein) as both means for acquiring and processing the samples, such embodiments prevent sample loss during transfer (e.g., as a result of surface tension-related effects), during processing (e.g., as a result of evaporation), or otherwise. These embodiments, accordingly, permit sample sizes smaller than 2 microliters to be processed with high accuracy.

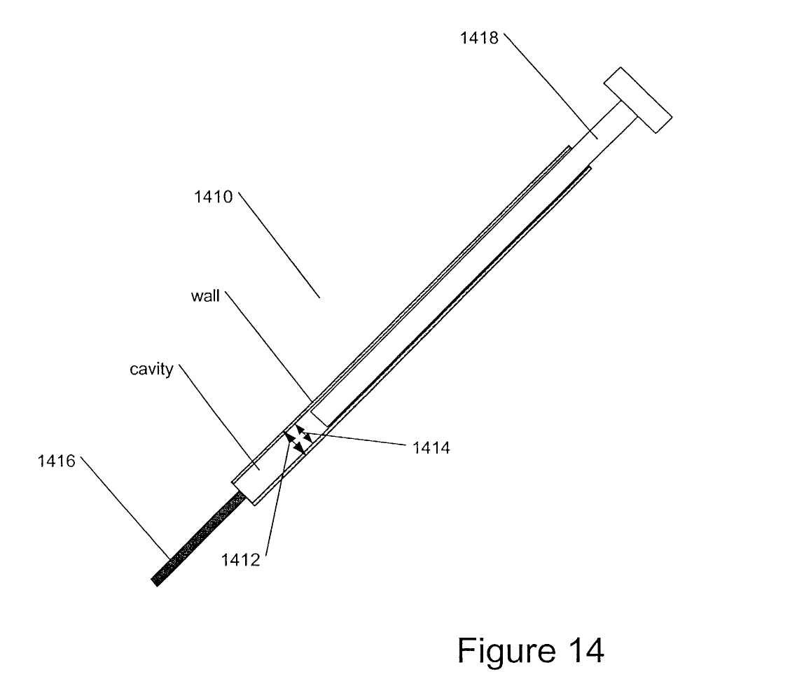

FIG. 14 depicts a nano-pipetter according to one practice of the invention. The illustrated device is a 90 mm long glass capillary chamber 1410 having a 1000 micron outer diameter 1412 and a 500 micron inner diameter 1414. A tip 1416, comprising a stainless steel hypodermic tube 25 mm long with an outer diameter of 500 microns and an inner diameter of 250 microns, is fitted at one end. The illustrated nano-pipetter may be used for sample sizes from 50 nanoliters to several microliters.

Both larger and smaller sample sizes may be processed by nano-pipetters of other dimensions. Thus, for example, the invention contemplates capillary-like chambers with wall thicknesses substantially equal to or under 1000 microns, 750 microns, 500 microns, or 250 microns, with the choice of thickness depending upon the availability of materials and suitability for intended use. Likewise, the chambers can have inner wall diameters (i.e., reaction cavity outer diameters) substantially equal to or under 1000 microns, 750 microns, 500 microns, or 250 microns. Once again, the choice depends on availability and suitability. Any combination of these aforementioned wall thicknesses and inner wall diameters may be employed.

Such nano-pipetters may be of lengths suitable for the sample volumes to be processed and the workstation processing equipment with which they are used. Nanopipetters according to the invention can be used to process samples substantially equal to or under 10 microliters, 1 microliter, 100 nanoliters, 50 nanoliters, and/or under 10 nanoliters.

The illustrated nano-pipetters are preferably used with tips, e.g., of the type described above or equivalents, though, they may be used without tips. Preferred nano-pipetters are of circular cross-section, though, other cross-sections may be used instead. The pipetters may be constructed from glass, as indicated above, or from any other suitable substance or compound. Likewise, the tips and plungers may be constructed from stainless steel, other metals, ceramics, plastics, or other suitable substances.

Biological, chemical and other samples are introduced and dispensed from the nano-pipetter of FIG. 14 via a plunger 1418 that, when drawn back, causes samples to be aspirated into the cavity or, when pushed forward, causes them to be dispensed from the cavity. Other techniques known in the pipetting art may be used instead to introduce or dispense samples from the pipetter. These include application of negative (vacuum) and positive pressures, capillary action, and so forth.

Regardless of their sizes and configurations, a set of such nano-pipetters may be “ganged” together. Indeed, in one embodiment of the invention, an automated workstation of the type discussed above utilizes 96 nano-pipetters configured and operated in the manner of the pipetter-type end effectors shown in FIGS. 9-13 (e.g., including tip washing mechanisms, back-flushing mechanisms and fluid level detection mechanisms) and also described above. Nano-pipetters according to the invention can also be used individually in other automated apparatus and configurations, as well as in non-automated applications.

Unlike the prior art, in which pipetter-type devices are used to transfer specimens to and from reaction vessels, nano-pipetters according to the invention are used as reaction vessels directly. By way of example, two or more liquids or liquid suspensions may be mixed within the nano-pipetter as follows. The liquids are sequentially drawn into the chamber without an air gap between them. By moving the plunger back and forth (or otherwise agitating the samples), the fluids are very efficiently mixed. This is due to the fact that near the walls of the nano-pipetter chamber, the fluids move more slowly than near the center (boundary layer effect). Thus, within the fluid volume, the difference in velocity creates a “churning” which provides effective mixing. This effect is most pronounced with small diameter chambers (high Reynolds number).

By way of further example, samples within the nano-pipetters are heated, cooled or other processed thermally by placing the nano-pipetters in environments with appropriately controlled temperatures. This may be in the form of air streams, fluid streams, stationary fluids, or solid block contact. Samples may be rapidly thermally cycled by sequentially changing the temperatures of the surrounding environments. To insure that the samples do not move within the nano-pipetters, their tips are pressed against a compliant sealing surface so that pressure from expansion or contraction is equalized on both sides of the sample.

A further non-limiting example of an application of a nanopipetter according to the invention is the high-throughput processing of small-volume samples for DNA sequencing in connection with the Human Genome Project. The steps in DNA sequencing that can utilize nanopipet technology include but are not limited to aspiration of raw DNA from cells, reagent addition, polymerase chain reaction (PCR) amplification, purification, reagent addition, cycle sequencing, purification, and loading into electrophoresis gels.

By way of still further example, nano-pipetters according to the invention are used for separation and purification via processing under influence of a magnetic field. To this end, samples are mixed with ferromagnetic or paramagnetic (collectively, “magnetic”) beads, e.g., of the type available from Dynal, Inc., that bind to selected components in the samples. Mixing can be accomplished prior to introduction of the samples to the nano-pipetters or while the samples are within the nano-pipetters.

The pipetters and contained samples are placed within a magnetic field, e.g., via placing small, powerful magnets against or in close proximity to the outsides of the pipetter chambers. This entrains the magnetic beads and components to which they are bound, attracting them against the inner walls of the chambers. Separation may be accelerated by reciprocating the nano-pipetter plungers back and forth so that all portions of the samples pass in close proximity to the magnet or are otherwise exposed to the magnetic field. Care, however, should be taken not to disrupt the beads already entrained by the magnets.

Once the magnetic beads and bound sample components are entrained against the walls of the pipetters, the plunger is retracted and the non-bound portions of the sample pulled away from the entrained or localized portions. Either at the same time or subsequent to plunger retraction, a resuspension fluid is aspirated into the chamber and brought into contact with the beads. This fluid is separated from the original (non-bound) portion of the sample by an air gap. The magnet is then removed and the beads are mixed with the resuspension fluid by back-and-forth plunger motion. The resuspension fluid and beads are then expelled, leaving the non-bound portion of the original sample for dispensing or further processing.

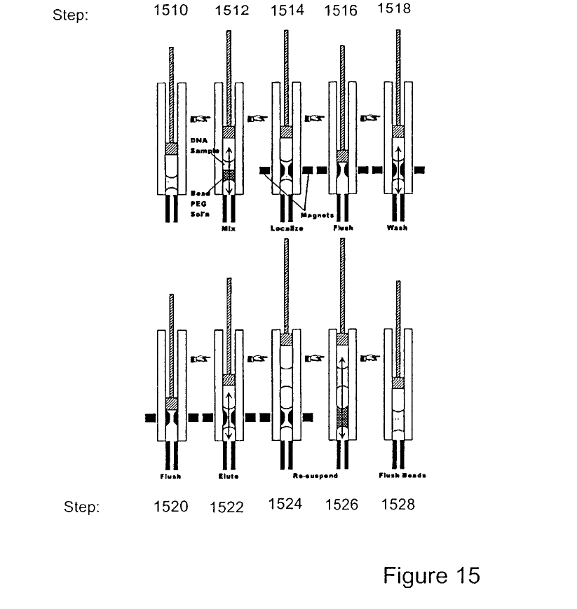

A preferred embodiment of the invention utilizes the above-described nano-pipetters in conjunction with processing nucleic acid samples in a magnetic field in accord with the methodology shown in FIG. 15. To this end, a sample solution containing a nucleic acid, such as DNA, is drawn into a nano-pipetter (Step 1510). A second solution containing magnetic beads that will bind to DNA (such as through biotin-streptavidin binding) and a precipitant (such as polyethylene glycol) is also drawn into the nano-pipetter preferably without an air gap between the first and second solutions (Step 1512). The two solutions are preferably mixed by reciprocating the plunger (also, Step 1512). The precipitated DNA is thus bound by the magnetic beads.

The magnetic beads are localized to the inner wall of the nano-pipetter by placing it against or in close proximity to a strong magnetic (Step 1514). The mixed solution without the magnetic beads and the DNA are dispensed from the pipette (Step 1516). Optionally, a solution for washing the DNA sample may be drawn into the nano-pipetter while the beads remain localized by the magnet (Step 1518). The wash solution is dispensed after the wash is complete (Step 1520). The wash may be performed with or without localization of the beads by a magnet. If the wash is performed without a magnet, the beads are subsequently localized by the magnet after the wash is complete.

An elution solution is drawn into the nano-pipetter to remove the nucleic acid sample from the magnetic beads (Step 1522). The elution step can be performed with or without localization of the beads by a magnet.

After elution of the DNA from the beads, the DNA is separated from the beads by drawing the elution solution further into the nano-pipetter or dispensing the solution contained eluted DNA from the pipetter. If the DNA solution is drawn further into the pipetter with an air bubble, another solution can be drawn into the pipette to flush the beads from the pipette (Steps 1524-1528). After flushing the beads, the DNA solution in the pipette can be further processed while inside the pipette.

A further appreciation of the structure of an apparatus according to the invention may be attained by reference to the Appendix, in which Appendix A1 is an exploded perspective view showing of a workstation according to the invention and particularly showing, the cassette storage areas, work area, robotic arm and robotic arm drive mechanisms; Appendix A2 is the front view of a robotic arm according to the invention equipped with a single-pipette end effector with a tip and plate washing apparatus of the type shown in FIG. 10; Appendix A3-A7 are front, top and side view of a robotic arm according to the invention equipped with a basic end effector of the type shown in FIGS. 7-8 and equipped with a twelve-tip pipette of the type shown in FIG. 9; Appendix A8 is a three-dimensional depiction of a twelve-tip pipette of the type shown in FIG. 9. With further reference to Appendix A3-A7, Appendix A5 is a top view of the end effector. Front and side views with the basic end effector retracted are shown in Appendix A3 and A4. Front and side views with the basic end effector extended are shown in Appendix A6 and A7.

Described herein are automated workstations, robotic arms, robotic arm positioning mechanisms, plate handling mechanisms, effector tip/plate washing mechanisms, back-flushing mechanisms, fluid level detection mechanisms, and nano-pipetters (or other such apparatus) as well as methods of operation thereof, meeting the objects set forth above. Those skilled in the art will appreciate that the embodiments discussed and illustrated herein are examples of the invention and that other apparatus and methods incorporating equivalents thereof and other changes therein fall within the scope of the invention, of which we claim:

[image]

[image]

[image]

[image]

[image]

[image]

[image]

1. An automated workstation, comprising
A. a storage area capable of holding one or more specimens, the storage area having first and second accesses;
B. a robotic arm disposed for accessing specimens in the storage area via the first access; and
C. an interlock that prevents access to the specimens in the storage area via the second access when the robotic arm is accessing the specimens via the first access.

2. An automated workstation according to claim 1, comprising a panel for removably blocking the second access, wherein the interlock prevents the panel from being removed from blocking the second access when the robotic arm is accessing the specimens via the first access.

3. An automated workstation according to claim 1, wherein the interlock prevents the robotic arm from accessing the specimens in the storage area via the first access when the specimens are being accessed via the second access.

4. An automated workstation according to claim 1, comprising a panel for removably blocking the first access, wherein the interlock prevents the panel from being removed from blocking the first access when the specimens are being access via the second access.

5. An automated workstation, comprising
A. a storage area capable of holding a cassette containing zero, one or more specimens, the storage area having first and second accesses;
B. first and second panels for removable blocking the first and second accesses, respectively;
C. a robotic arm disposed for at least one of (i) removing specimens from and (ii) placing specimens in the cassette, via the first access; and
D. an interlock that at least one of (i) prevents the first panel from being removed from blocking the first access when the cassette is being accessed via the second access, and (ii) prevents the second panel from being removed from blocking the second access when the cassette is being accessed via the first access.

6. An automated workstation according to claim 5, wherein the interlock at least one of (i) prevents the first panel from being removed from blocking the first access when the second panel has been removed from blocking the second access, and (ii) prevents the second panel from being removed from blocking the second access when the first panel has been removed from blocking the first access.

7. An automated workstation, comprising
A. a storage area capable of holding a cassette containing zero, one or more specimens, the storage area having first and second accesses that are removably blocked by first and second panels, respectively;
B. a work area comprising at least one of (i) a transfer station and (ii) an apparatus for placing or processing a specimen;
C. a robotic arm that transfers specimens between the cassettes and the work area via the first access; and
D. an interlock that at least one of (i) prevents the first panel from being removed from blocking the first access when the cassette is being accessed via the second access, (ii) prevents the second panel from being removed from blocking the second access when the cassette is being accessed via the first access, and (iii) prevents at least selected action of the robotic arm when the storage area is being accessed by an operator through any of the first and second accesses, respectively.

8. An automated workstation according to claim 7, wherein the interlock at least one of (i) prevents the first panel from being removed from blocking the first access when the second panel has been removed from blocking the second access, (ii) prevents the second panel from being removed from blocking the second access when the first panel has been removed from blocking the first access.

9. An automated workstation according to claim 8, comprising
a third panel for removably blocking access to the work area,
wherein the interlock prevents any of (i) the third panel from being removed when the robotic arm is moving therein, and (ii) at least selected action of the robotic arm when the work area is being accessed by an operator.

10. An automated workstation according to claim 7, wherein at least one of the storage area and the work area is environmentally controlled.

11. An automated workstation according to claim 10, comprising apparatus that generates at least one of cooled, warmed, humidified, dehumidified or otherwise processed gas for transfer to at least one of the storage area and work area.

12. An automated workstation according to claim 7, comprising a carriage for moving the robotic arm, the carriage being disposed above the work area.

13. Apparatus for positioning a robotic arm, the apparatus comprising
A. a first carriage arranged for motion along a first axis;
B. a second disposed on the first carriage for motion along a second axis;
C. a first plurality of wheels disposed stationarily relative to the first and second carriages, and a second plurality of wheels disposed on the first carriage;
D. at least two of the wheels comprising drive wheels;
E. a drive belt defining a pathway about the wheels and having two ends that are coupled to the second carriage, the drive belt being so arranged that rotation of the drive wheels results in translation of the second carriage along at least one of the first and second axes.

14. An automated workstation, comprising
A. a storage area capable of holding specimens;
B. a work area comprising at least one of (i) a transfer station and (ii) an apparatus for placing or processing a specimen;
C. a robotic arm that transfers specimens between the cassettes and the work area via the first access, the robotic arm being disposed on a track that is situated above the work area and that is oriented along a first axis;
D. a first carriage arranged for motion along the track;
E. a second disposed on the first carriage for motion along a second axis, the second axis being substantially orthogonal to the first axis;
F. a first plurality of wheels disposed stationarily relative to the first and second carriages, and a second plurality of wheels disposed on the first carriage, at least two of the wheels comprising drive wheels;
G. a drive belt defining a pathway about the wheels and having two ends that are coupled to the second carriage, the drive belt being so arranged that rotation of the drive wheels results in translation of the second carriage along at least one of the first and second axes.

15. Apparatus according to any of claims 13 and 14, wherein the first plurality of wheels are disposed at locations defining vertices of a first rectangle having a longitudinal axis substantially parallel to the first axis, and wherein the second plurality of wheels are disposed at locations defining vertices of a second rectangle having a longitudinal axis substantially parallel to the second axis.

16. Apparatus according to claim 15, wherein the drive belt pathway is substantially H-shaped.

17. Apparatus according to claim 15, wherein the first plurality of wheels includes the drive wheels and wherein those drive wheels are disposed at opposing vertices of the first rectangle with respect to a midline running parallel to the first axis.

18. Apparatus according to any of claims 13 and 14, wherein one or more wheels of wheels are biasedly mounted so as to affect tension in the belt.

19. A robotic arm disposed on a mount, the arm comprising:
A. a first portion that extends along a first axis and that is finely positionable along that axis; and
B. a second portion that is coupled to the first portion and that extends between first and second positions in a direction of the first axis.

20. A robotic arm according to claim 19, wherein any of the first and second portions are coupled to a mount that moves along a plane, and wherein the first axis is substantially normal to that plane.

21. A robotic arm according to claim 20, wherein the mount moves along any of x- and y-axes and wherein the first and second sections extend along a z-axis.

22. A robotic arm disposed on a mount, the arm comprising:
A. a first extensible section comprising
i) a first frame;
ii) a finely-positionable motor-driven element that is coupled to the mount;
iii) a motor that is coupled to the frame and that is coupled to the motor-driven element, the motor driving the motor-driven element relative to the mount and, thereby, translating the first frame relative to the mount;
B. a second extensible section comprising
i) a second frame;
ii) an actuator that is coupled to the first and second frames, whereby actuation of the actuator translates the second frame relative to the first frame.

23. A robotic arm according to claim 22, comprising one or more effectors coupled to any of the first and second extensible sections.

24. A robotic arm according to claim 22, wherein the motor-driven element is a screw that is threadably coupled in the mount, and wherein the motor is mounted to the frame.

25. A robotic arm according to claim 22, wherein the actuator comprises
A. a housing that is affixed to the first frame,
B. an extensible portion that is affixed to the second frame.

26. An apparatus comprising
A. first and second carriages, the first carriage arranged for motion along a first axis and the second carriage disposed on the first carriage for motion along a second axis;
B. first and second pluralities of wheels, the first plurality being disposed stationarily, the second plurality of wheels being disposed on the first carriage, at least two of the wheels in either of the first and second plurality of sets comprising drive wheels;
C. a drive belt defining a pathway about the wheels and having two ends that are coupled to the second carriage, the drive belt being so arranged that rotation of the drive wheels results in translation of the second carriage along at least one of the first and second axes; and
D. a robotic arm disposed on the second carriage, the robotic arm comprising
i) a first section that is affixed to the second carriage and that translates along a third axis via action of a motor;
ii) a second section that is affixed to the first section and that translates along the third axis.

27. An apparatus according to claim 26, wherein the first section comprises
A. a first frame;
B. a finely-positionable motor-driven element that is coupled to the mount; and
C. a motor that is coupled to the frame and that is coupled to the motor-driven element, the motor driving the motor-driven element relative to the mount and, thereby, translating the first frame relative to the mount;

28. An apparatus according to claim 26, wherein the second section comprises:
A. a second frame; and
B. an actuator that is coupled to the first and second frames, whereby actuation of the actuator translates the second frame relative to the first frame;

29. An apparatus according to claim 28, wherein the motor-driven element is a screw that is threadably coupled in the mount, and wherein the motor is mounted to the first frame.

30. An apparatus according to claim 28, wherein the actuator comprises
A. a housing that is affixed to the first frame,
B. an extensible portion that is affixed to the second frame.

31. An apparatus according to claim 22, comprising one or more effectors coupled to any of the first and second extensible sections for motion along the third axis.

32. An apparatus according to claim 31, wherein the effectors comprise any of handling apparatus, rinse apparatus, probes, pipettes and other handling and processing apparatus.

33. A plate handling apparatus for use with a robotic arm, the plate handling apparatus comprising a first member for engaging a plate when the arm is positioned adjacent a side of the plate and a second member for engaging a plate when the arm is positioned adjacent a top of the plate.

34. A plate handling apparatus according to claim 33, wherein the first member comprises one or more elongate elements.

35. A plate handling apparatus according to claim 34, wherein a distal end of at least one of the elongate elements includes a protuberance.

36. A plate handling apparatus according to claim 35, wherein the protuberance comprises a hook-shaped end of the respective elongate element.

37. A plate handling apparatus according to claim 34, wherein at least one of the elongate elements is arranged for any of extension and retraction from the arm.

38. A plate handling apparatus according to claim 33, wherein the second member comprises one or more elements arranged for inward and outward motion relative to a central region of the effector.

39. A plate handling apparatus according to claim 33, wherein the second member comprises a plurality of elements arranged for any of pinching or grasping the plate.

40. A plate handling apparatus for use with a robotic arm, the plate handling apparatus comprising
A. a first member for engaging a plate when the arm is positioned adjacent a side of the plate, the first member comprising one or more elongate elements arranged for extension from the arm;
B. a second member for engaging a plate when the arm is positioned adjacent a top of the plate, the second member comprising a plurality of elements arranged for any of pinching or grasping the plate.

41. A plate handling apparatus according to claim 40, comprising a sensor that detects information regarding a plate.

42. A plate handling apparatus according to claim 41, wherein the sensor comprises an optical sensor.

43. A plate handling apparatus according to claim 41, wherein the optical sensor is arranged to detect information from plates disposed on multiple sides of the arm.

44. A plate handling apparatus according to claim 41, wherein the optical sensor comprises a beam splitter defining multiple optical sensing pathways.

45. A plate handling apparatus according to claim 42, wherein the optical sensor comprises a bar code reader.

46. A plate handling apparatus for use with a robotic arm, the plate handling apparatus comprising
A. a first member for engaging a plate when the arm is positioned adjacent a side of the plate, the first member comprising one or more elongate elements arranged for extension from the arm;
B. a second member for engaging a plate when the arm is positioned adjacent a top of the plate, the second member comprising a plurality of elements arranged for any of pinching or grasping the plate; and
C. an optical sensor for sensing indicia disposed on the plate, the optical sensor comprising a bar code reader and a beam splitter defining multiple optical sensing pathways.

47. A robotic arm disposed on a mount, the arm comprising:
A. a first extensible section comprising
i) a first frame;
ii) a finely-positionable, motor-driven element that is coupled to the mount;
iii) a motor that is coupled to the frame and that is coupled to the motor-driven element, the motor driving the motor-driven element relative to the mount and, thereby, translating the first frame relative to the mount;
B. a second extensible section comprising
i) a second frame;
ii) an actuator that is coupled to the first and second frames, whereby actuation of the actuator translates the second frame relative to the first frame;
C. a plate handling apparatus coupled to any of the first and second extensible section, the plate handling member comprising
i) a first member for engaging a plate when the arm is positioned adjacent a side of the plate, the first member comprising one or more elongate elements arranged for extension from the arm; and
ii) a second member for engaging a plate when the arm is positioned adjacent a top of the plate, the second member comprising a plurality of elements arranged for any of pinching or grasping the plate.
iii) an optical sensor for sensing indicia disposed on the plate, the optical sensor comprising a bar code reader and a beam splitter defining multiple optical sensing pathways.

48. In a specimen handling apparatus for use with a moveable robotic arm, the improvement comprising a wash fluid outlet disposed on the specimen handling apparatus.

49. In a specimen handling apparatus according to claim 48, the improvement wherein the wash fluid outlet comprises a cup for washing at least a portion of a specimen processing device disposed on the specimen handling apparatus.

50. In a specimen handling apparatus according to claim 49, the improvement wherein the specimen processing device comprises a tip and wherein the wash fluid outlet comprises a cup for washing that tip.

51. In a specimen handling apparatus according to claim 50, the improvement wherein the specimen processing device comprises a pipette.

52. In a specimen handling apparatus according to claim 49, the further improvement wherein the cup comprises a fluid port for washing any of a specimen or a specimen plate.

53. A robotic arm disposed on a moveable carriage, the arm comprising:
A. a first portion that is coupled to the mount and that extends via action of a motor;
B. a second portion that is coupled to the first portion and that extends therefrom;
C. a specimen handling apparatus coupled to any of the first and second portions, the specimen handling apparatus comprising a wash cup for washing at least a portion of a specimen processing device disposed on the specimen handling apparatus.

54. A robotic arm according to claim 53, wherein wash cup is arranged for translation between an inoperative position and an operative position.

55. A robotic arm according to claim 54, wherein wash cup is arranged for pivoting into an operative position.

56. A robotic arm according to claim 55, wherein the wash cup comprises a fluid port for washing any of a specimen or a specimen plate.

57. A fluid handling apparatus for use with a robotic arm, the apparatus comprising
A. a body for holding fluid, the body having a first fluid outlet;
B. a plunger slidably disposed within the body for at least one of expelling and drawing fluid via the first fluid outlet; and
C. a fluid inlet disposed for introducing fluid into the body, the fluid inlet being blocked by the plunger when the plunger is disposed in a first position, the fluid inlet not being blocked by the plunger when the plunger is disposed in a second position.

58. A fluid handling apparatus according to claim 57, wherein the body comprises a pipette and the first fluid outlet comprises a pipette tip.

59. A fluid handling apparatus according to claim 57, wherein the fluid inlet is disposed at an opposite end of the body from the first fluid outlet.

60. A fluid handling apparatus according to claim 57, wherein the plunger blocks the fluid inlet when the plunger is disposed within the body and wherein the plunger does not block the fluid inlet when the plunger is disposed outside the body.

61. A pipette apparatus for use with a robotic arm, the apparatus comprising
A. a body for holding fluid, the body having a tip;
B. a wash fluid inlet disposed at an end of the body opposite that of the tip;
C. a plunger slidably disposed within the body for at least one of expelling and drawing fluid via the tip, the plunger blocking the wash fluid inlet when the plunger is at least one of expelling and drawing fluid via the tip; and
D. the plunger being arranged for being drawn at least partially out of the body so as not to block the fluid inlet, thereby, permitting wash fluid to pass therefrom.

62. A pipette apparatus according to claim 61, comprising a fluid outlet providing an egress for the wash fluid.

63. A pipette apparatus according to claim 62, wherein the fluid outlet can be selectively opened thereby affecting a flow of wash fluid through the tip.

64. A fluid handling apparatus for use with a robotic arm, the apparatus comprising
A. a body for holding fluid; and
B. an optical detector for detecting at least one of a presence and a level of fluid in the body.

65. A fluid handling apparatus according to claim 64, comprising an illumination source that generates radiation for detection by the optical detector.

66. A fluid handling apparatus according to claim 65, wherein the optical detector generates an output as a function of radiation detected thereby.

67. A fluid handling apparatus according to claim 66, wherein the optical detector output at least one increases and decreases as a function of any of the presence and level of fluid in the body.

68. A pipette apparatus for use with a robotic arm, the apparatus comprising
A. a body for holding fluid;
B. an illumination source; and
C. an optical detector for detecting at least one of a presence and a level of fluid in the body.

69. A pipette apparatus for use with a robotic arm, the apparatus comprising
A. a plurality of bodies, each for holding fluid;
B. an illumination source; and
C. an optical detector for detecting at least one of a presence and a level of fluid in one or more of the bodies.

70. The pipette apparatus of claims 61, 68, and 69, wherein at least one body for holding fluid comprises a capillary having a wall defining a cavity for holding the fluid, the cavity having an average diameter substantially equal to or under any of 1000 microns, 750 microns, 500 microns and 250 microns, the wall having an average thickness substantially equal to or under any of 1000 microns, 750 microns, 500 microns and 250 microns.

71. A method of processing biological and chemical samples, the method comprising steps of:
introducing a sample into a pipetter having a wall defining a cavity for holding the fluid, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters, and processing the sample within the pipetter.

72. The method of claim 71, comprising the steps of
introducing first and second samples into the pipetter,
mixing the first and second samples within the pipetter.

73. The method of claim 72, wherein the mixing step comprises reciprocating a plunger within the pipetter.

74. The method of claim 72, wherein the processing step comprises any of heating and cooling the pipetter.

75. The method of claim 74, wherein the processing step comprises exposing the pipetter to one or more thermally controlled environments.

76. The method of claim 72, wherein the processing step comprises exposing the pipetter to a magnetic field.

77. A method of thermally processing small volume biological and chemical samples, said method comprising steps of:
introducing a sample into a body having a wall defining a cavity for holding the fluid, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the sample having a volume substantially equal to or under any of 10 microliters, 1 microliter, 100 nanoliters, 50 nanoliters, and under 10 nanoliters, and exposing the body to any of heating and cooling.

78. The method of claim 77, wherein the exposing step comprises exposing the body to one or more thermally controlled environments.

79. A method of isolating components of small volume biological or chemical samples, said method comprising steps of:
introducing a sample into a body having a wall defining a cavity for holding the fluid, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the sample having a volume substantially equal to or under any of 10 microliters, 1 microliter, 100 nanoliters, 50 nanoliters, and under 10 nanoliters, the sample including any of a ferromagnetic and a paramagnetic component (collectively, “magnetic component”), and
placing the body in a magnetic field, thereby, at least partially separating the magnetic component from one or more other components in the sample.

80. A method of isolating components of a small volume biological or chemical sample, said method comprising steps of:
mixing the sample with magnetic beads,
introducing the sample and beads into a body having a wall defining a cavity for holding the fluid, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the introduced sample and beads having a fluid volume substantially equal to or under any of 10 microliters, 1 microliter, 100 nanoliters, 50 nanoliters, and under 10 nanoliters,
placing the body into a magnetic field, thereby, at least partially localizing the magnetic compound and any components of the sample bound therewith,
any of separating and processing separately the bound components of the sample from any other components of the sample.

81. A nanopipetter for processing small volume fluid samples comprising:
a thin-walled cylindrical chamber for housing samples; and
a plunger slidably disposed of within the cylindrical chamber.

82. The nanopipetter of claim 81, wherein the thin-walled cylindrical chamber comprises a body having a wall defining a cavity for holding the fluid, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

83. An automated workstation comprising:
a robotic arm having an effector end; and
at least one thin-walled pipetter attached to the effector end of the robotic arm, the thin-walled pipetter comprising a body having a wall defining a cavity for holding the fluid, the cavity having an average diameter substantially equal to or under any of 1000 microns, 750 microns, 500 microns and 250 microns, the wall having an average thickness substantially equal to or under any of 1000 microns, 750 microns, 500 microns and 250 microns.

84. A robotic arm comprising:
A. first and second extensible portions that are coupled to one another,
B. the first extensible portion being extendable between first and second positions along a first axis,
C. the second extensible portion being extendable to a range of positions along the first axis and providing fine motion control therealong.

85. A robotic arm according to claim 84, wherein the first extensible portion extends pneumatically.

86. A robotic arm according to claim 85, wherein the second extensible portion extends via action of any of a motor and a screw.

87. A robotic arm according to claim 84, wherein the first extensible portion extends pneumatically and the second extensible portion extends via action of any of a motor and a screw.

88. A robotic arm according to claim 87, wherein the second extensible portion is coupled to a mount and extends therefrom, and wherein the first extensible portion is coupled to the second extensible portion is extends therefrom.

89. A robotic arm according to claim 88, wherein the mount is moveable along of any of second and third axes.

90. A robotic arm according to claim 89, wherein the first axis is a z-axis and wherein the first and second axes are x- and y-axes.
